(19) United States
(12) Patent Application Publication
(10) Pub. No.: US 2010/0292988 A1
(43) Pub. Date: Nov. 18, 2010

(54) SYSTEM AND METHOD FOR SPEECH RECOGNITION

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/538,836

(22) Filed: Aug. 10, 2009

(30) Foreign Application Priority Data
May 13, 2009 (CN) 200910302276.4

(51) Int. Cl. G10L 15/06

(52) U.S. Cl. 704/243; 704/E15.002

(57) ABSTRACT

A speech recognition system samples speech signals having the same meaning, and obtains frequency spectrum images of the speech signals. Training objects are obtained by modifying the frequency spectrum images to be the same width. The speech recognition system obtains specific data of the speech signals by analyzing the training objects. The specific data is linked with the meaning of the speech signals. The specific data may include probability values representing probabilities that the training objects appear at different points in an image area of the training objects. A speech command may be sampled, and a frequency spectrum image of the speech command is modified to be the same width as the training objects. The speech recognition system can determine a meaning of a speech command by determining a matching degree of the modified frequency spectrum image of the speech command and the specific data of the speech signals.

### BACKGROUND

1. Technical Field

The present disclosure relates to speech controlling systems, and more particularly to a speech recognition system and a method for an electronic device.

2. Description of Related Art

Voice control technology can be used with a variety of electronic devices, such as robots, electronic toys, telephones, and home appliances. Behaviors of the electronic devices can be controlled by voice commands of users. For example, a robot may turn left or turn right when receiving a corresponding voice command from a user. However, speech recognition technology is not yet perfected and the electronic devices may not recognize commands correctly and thus perform the wrong actions.

### BRIEF DESCRIPTION OF THE DRAWINGS

FIG. 1 is a block diagram of an embodiment of a speech recognition system; the speech recognition system includes a spectrum modifying module.

FIG. 2 is a schematic diagram of frequency spectrums of a plurality of speech signals converted into a plurality of training objects by the spectrum modifying module of FIG. 1.

FIG. 3 is a flowchart of an embodiment of a speech recognition method.

### DETAILED DESCRIPTION

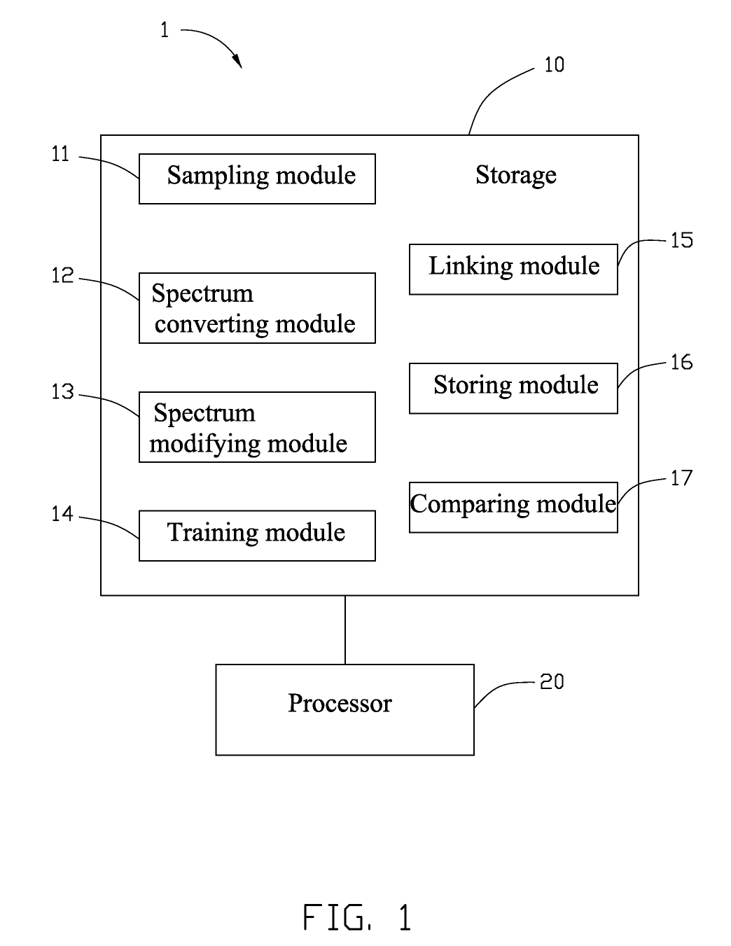

Referring to FIG. 1, an embodiment of a speech recognition system 1 includes a storage 10 and a processor 20. The storage 10 includes a sampling module 11, a spectrum converting module 12, a spectrum modifying module 13, a training module 14, a linking module 15, a storing module 16, and a comparing module 17. The sampling module 11, spectrum converting module 12, spectrum modifying module 13, training module 14, linking module 15, storing module 16, and comparing module 17 may include one or more computerized instructions and are executed by the processor 20. The speech recognition system 1 is operable to recognize meaning of a voice command by obtaining a specific feature of the speech command according to a frequency spectrum of the speech command.

The sampling module 11 samples a plurality of speech signals which are repeatedly produced by an acoustic sound source.

The spectrum converting module 12 obtains frequency spectrum images of each of the plurality of speech signals by examining frequency spectral compositions of each of the plurality of speech signals. The spectrum modifying module 13 adjusts the frequency spectrum images of the plurality of speech signals so that they all are the same width to obtain a plurality of training objects, as detailed below.

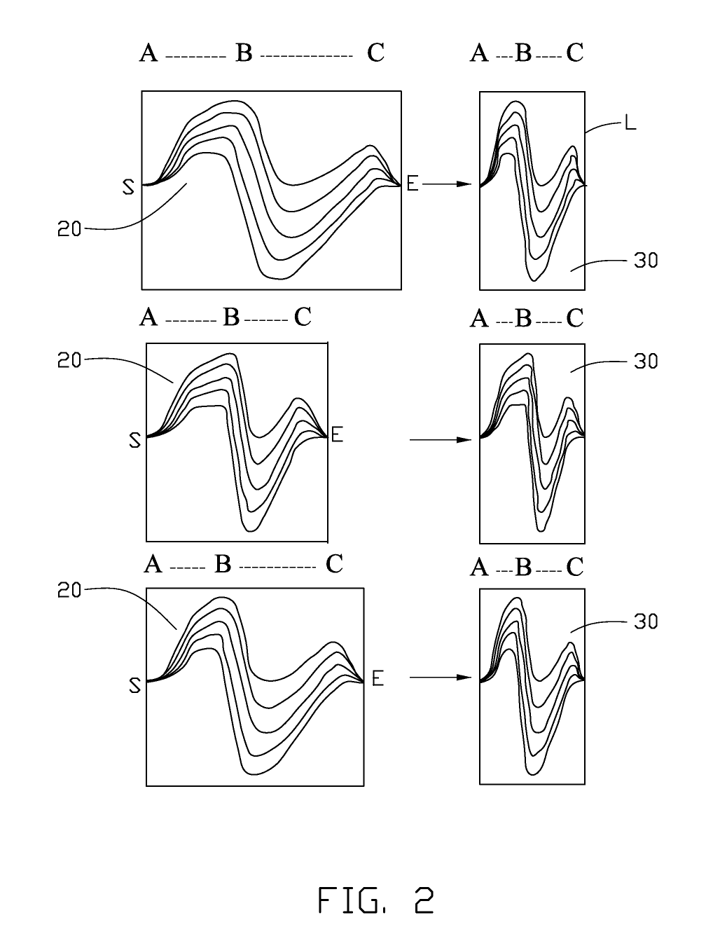

Referring to FIG. 2, for example, the spectrum converting module 12 may obtain three frequency spectrum images 20 of three speech signals. Each of the three speech signals includes three Chinese words. Each of the three speech signals means “turn left” in Chinese language. In the illustrated embodiment, the three Chinese words are respectively denoted by “A”, “B”, and “C.” The three frequency spectrum images 20 are similar in shape. Lengths of the three frequency spectrum images 20 are different from one another, because there are small differences between the three speech signals. A start point S and an end point E are labeled by the spectrum modifying module 13. The frequency spectrum images 20 are modified to all be the same width by adjusting the start point S and the end point E of each of the frequency spectrum images 20 to have a predetermined distance therebetween. Therefore, three training objects 30 of the three speech signals are obtained.

The training module 14 obtains specific data of the plurality of speech signals by analyzing the training objects of the plurality of speech signals. In this embodiment, the specific data includes a set of probability values. Each of the probability values is obtained by overlapping the training objects. Each of the probability values represents a probability that the training objects appear at a point in an image area. The image area is formed by lines that enclose the overlapped training objects. In this illustrated embodiment, a rectangular image area is formed by four lines L that enclose each of the training objects 30. The rectangular image areas have the same length and width. The rectangular image areas with the training objects 30 may be overlapped to allow the training module 14 to calculate a set of probability values, which represent probabilities that the training objects 30 appear at different points in the overlapped rectangular image areas. For example, there may be a 90% chance that the training objects 30 appear at one point in the overlapped rectangular image areas, and no chance that the training objects 30 appear at another point in the overlapped rectangular image areas. Each point at which 90% (or other predetermined probability value) that the training objects 30 appear may be considered a high coincidence point.

The linking module 15 links the specific data and the meaning of the speech signals together. The meaning of the speech signals may be preprogrammed in code, which can be executed by the processor 20 to control an electronic device to do something, such as turn left. The specific data and the linked meaning are stored in the storing module 16. In this embodiment, the storing module 16 can store specific data of a plurality of speech signals having different meanings.

Therefore, when a speech command is voiced in the area of the electronic device, the speech command is firstly sampled by the sampling module 11. A frequency spectrum image of the speech command is obtained, and is modified to be the same width as the training objects. Then the frequency spectrum image of the speech command is received by the comparing module 17.

The comparing module 17 compares the modified frequency spectrum image of the speech command with specific data of the plurality of speech signals stored in the storing module 16, to determine a meaning of the speech command. In this embodiment, the comparing module 17 may find a speech signal that is the nearest match to the speech command through a rough comparison of the modified frequency spectrum image of the speech command with specific data stored in the storing module 16. A similarity degree of the speech command and the speech signal is then determined according to the specific data of the speech signal, by overlapping the modified frequency spectrum image of the speech command to the image area. For example, the similarity degree may be 85% in response to the frequency spectrum image of the speech command being superposed on 85% of the high coincidence points of the overlapped rectangular square image areas. If the similarity degree is equal to or greater than a predetermined value then it is accepted as a match.

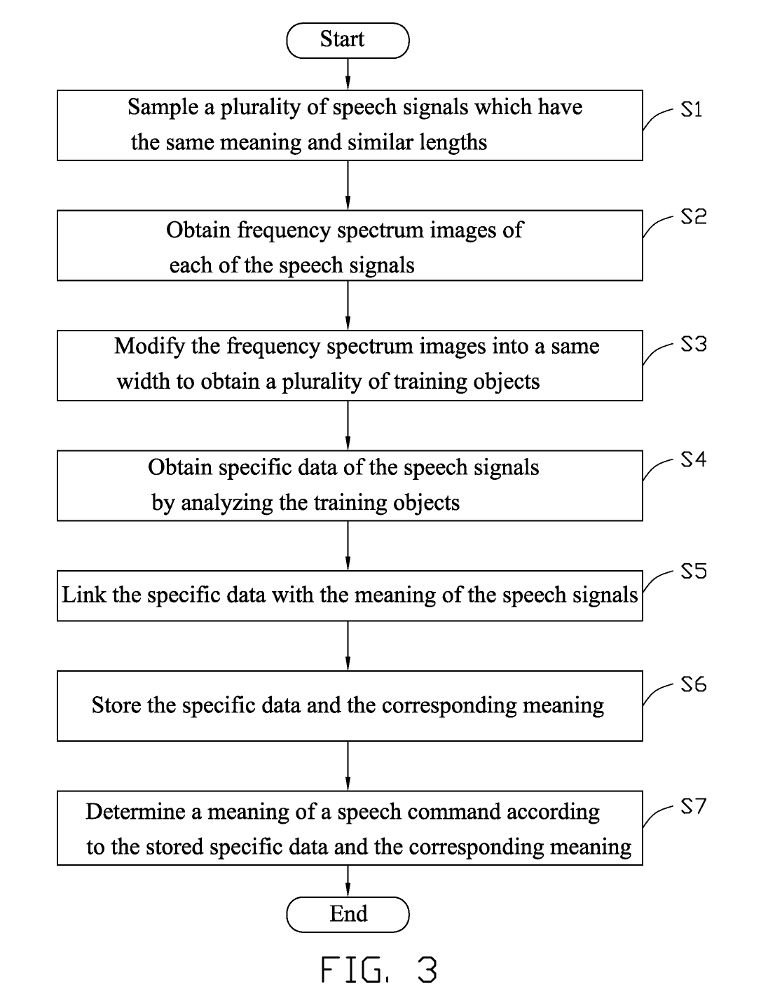

Referring to FIG. 3, an embodiment of a speech recognition method includes the following steps.

In step S1, the sampling module 11 samples a plurality of speech signals which have the same meanings and similar lengths.

In step S2, the spectrum converting module 12 obtains frequency spectrum images of each of the plurality of speech signals by examining frequency spectral compositions of each of the plurality of speech signals. There may be differences among the plurality of speech signals, such as duration, and loudness of the plurality of speech signals, therefore, the frequency spectrum images may be different in sizes.

In step S3, the spectrum modifying module 13 modifies the frequency spectrum images of the plurality of speech signals to be the same width to obtain a plurality of training objects. In this embodiment, the frequency spectrum images are modified by labeling the start point and the end point of each of the frequency spectrum images, and adjusting the start point S and the end point E of each of the frequency spectrum images 20 to have the predetermined distance therebetween.

In step S4, the training module 14 obtains specific data of the plurality of speech signals by analyzing the corresponding training objects. The specific data may represent a probability that the training objects appear at each point in the image area. The image area may include a plurality of high coincidence points.

In step S5, the linking module 15 links the specific data with the meaning of the speech signals. For example, the specific data may be linked with a meaning “dance.”

In step S6, the storing module 16 stores the specific data and the linked meaning. A plurality of speech signals having different meanings may be sampled in step S1, and therefore stored in the storing module 16 with corresponding meanings.

In step S7, the comparing module 17 determines a meaning of a speech command according to specific data and the linked meanings stored in the storing module 16. The comparing module 17 may find a speech signal that is the nearest match to the speech command through a rough comparison of a modified frequency spectrum image of the speech command with specific data stored in the storing module 16. A similarity degree of the speech command and the speech signal can be calculated by calculating a percentage that the modified frequency spectrum image of the speech command appearing at high coincidence points in an image area of the speech signal. It can be determined that the speech command has the same meaning with the speech signal, in response to the similarity degree being equal to or greater than the predetermined value.

In other embodiments, the system and method can be alternatively used in other acoustic recognition systems,

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A speech recognition system comprising:
a processor; and
a storage device connected to the processor and storing one or more computerized instructions to be executed by the processor, wherein the storage device comprises:
a sampling module sampling a plurality of speech signals having the same meanings from an acoustic sound source;
a spectrum converting module obtaining frequency spectrum images of each of the plurality of speech signals;
a spectrum modifying module adjusting the frequency spectrum images of the plurality of speech signals to be the same width to obtain a plurality of training objects;
a training module obtaining specific data of the plurality of speech signals by analyzing the plurality of training objects;
a linking module linking the specific data with the meaning of the plurality of speech signals;
a storing module storing the specific data and the corresponding meaning; and
a comparing module determining a meaning of a speech command according to the specific data and the linked meaning stored in the storing module.

2. The system of claim 1, wherein the specific data comprise a set of probability values, each of the probability values represents a probability that the plurality of training objects appear at a point in an image area formed by lines that enclose the plurality of training objects in response to the training objects being overlapped.

3. A speech recognition method comprising:
sampling a plurality of speech signals by a sampling module; the plurality of speech signals having the same meaning;
obtaining frequency spectrum images of each of the plurality of speech signals by a spectrum converting module;
obtaining a plurality of training objects by modifying the frequency spectrum images to be the same width;
obtaining specific data of the plurality of speech signals by analyzing the plurality of training objects by a training module;
linking the specific data with the meaning of the plurality of speech signals;
storing the specific data and the linked meaning; and
determining a meaning of a speech command according to the specific data and the corresponding meaning stored in the storing module by a comparing module.

4. The method of claim 3, further comprising:
repeatedly generating the plurality of speech signals by an acoustic sound source, wherein the plurality of speech signals are similar in length.

5. The method of claim 3, wherein the step of determining a meaning of a speech command comprises:
sampling the speech command by the sampling module;
obtaining a frequency spectrum image of the speech command by the spectrum converting module;
modifying the frequency spectrum image of the speech command to be the same width as the plurality of training objects;
determining a similarity degree of the speech command and the plurality of speech signals according to the frequency spectrum image of the speech and the specific data of the plurality of speech signals by the comparing module; and
determining a meaning of the speech command being the same as the meaning of the plurality of speech signals in response to the similarity degree being equal to or greater than a first predetermined value.

6. The method of claim 5, wherein the step of determining a similarity degree comprises:
overlapping the plurality of training objects;
forming an image area enclosing the overlapped training objects;
calculating a set of probability values, wherein each of the probability values represents a probability that the plurality of training objects appear at a point in the image area, the image area comprises a plurality of high coincidence points at which the probability values are equal to or greater than a second predetermined value;
overlapping the modified frequency spectrum image of the speech command on the overlapped training objects;
determining the similarity degree by calculating a percentage that the modified frequency spectrum image of the speech command appearing at the high coincidence points.

7. The method of claim 3, wherein the step of obtaining the plurality of training objects comprises:
labeling a start point and an end point of each of the frequency spectrum images, and adjusting the start point and the end point of each of the frequency spectrum images to have a predetermined distance therebetween.
